(19) United States
(12) Patent Application Publication
(10) Pub. No.: US 2025/0366454 A1
(43) Pub. Date: Dec. 4, 2025

(54) FISHING LINE CLIP DEVICE FOR FISHING REEL

(71) Applicant: MONEXKOREA CO.,LTD, Cheongju-si (KR)

(72) Inventor: Young Keun CHO, Cheongju-si (KR)

(21) Appl. No.: 18/991,689

(22) Filed: Dec. 22, 2024

(30) Foreign Application Priority Data
May 31, 2024 (KR) 10-2024-0071441

(51) Int. Cl. A01K 89/0155

(52) U.S. Cl. CPC A01K 89/0155

(57) ABSTRACT

Provided relates to a clip device for fixing an end portion of a fishing line of a fishing reel, including: a body member having a box-shaped structure with an open upper surface by coupling a support rod and a clamping rod; a movable member accommodated in the body member to be vertically movable, and configured to clamp the fishing line at a front thereof; and an elastic member interposed between the body member and the movable member. Accordingly, the clip device may stably fix the end portion of the fishing line that is wound during separation of the fishing reel from the fishing rod and storage of the fishing reel in a state where the end portion is in close contact with the level winder, so that a damage thereof may be prevented, thereby simultaneously improving convenience and durability.

### BACKGROUND OF THE INVENTION

### 1. Field of the invention

The present invention relates to a fishing line clip device for a fishing reel, and more specifically, to a fishing line clip device for a fishing reel to fix an end portion of a fishing line wound on the fishing reel.

### 2. Description of the Related Art

Fishing reels are commonly used in most types of fishing, such as freshwater lure fishing, saltwater lure fishing, and surf casting fishing. A user may turn a handle of the fishing reel to wind a line (fishing line) evenly on a spool. However, if the end portion of the fishing line is not stored by fixing a position thereof using a separate device, the fishing line is rolled into the spool or unwound from the spool and become misaligned, and thus if the end portion of the fishing line is not located at a top or end of the line, the line is not smoothly unwound, so that it is very inconvenient to fish. Typically, this inconvenience may be prevented by fixing the fishing line using a clip.

In this regard, Korean Registered Utility Model Publication No. 0194980 (Patent Document 1), Korean Registered Patent Publication No. 0361073 (Patent Document 2), and the like are known as related art documents.

The related art document 1 includes a hook into which a fishing needle may be inserted, an elastic assistant band connected to one end portion of the hook and attached to one end portion of a band body to connect the hook and the band body to each other, and the band body having a magic tape adhesive surface attached to the entire upper surface thereof. Accordingly, it is expected to prevent unwinding, twisting and tangling when using the reel by maintaining the fishing line in a taut state.

The related art document 2 is configured such that a fishing line fixture for fixing a fishing line is fastened to one side of a reel fishing rod on which a reel is installed, a protruding portion having a through-hole through which the fishing line passes is formed at a lower end of a semi-circular body of the fishing line fixture, and a spring and a pressing button are fastened to a bottom surface of the protruding portion to fix the same by a fixing plate. Accordingly, since the fishing line is fixed by the pressing button, it is expected to be used simply without a separate technique.

However, according to the related art documents, it is insufficient to prevent damage to the end portion of the fishing line and a level winder when the fishing reel is separately stored.

### Related Art Document

### Patent Document

(Patent Document 0001) Korean Registered Utility Model Publication No. 0194980 “BAND FOR PREVENTING UNWINDING OF REEL FISHING LINE” (Publication date: September 1, 2000.)

(Patent Document 0002) Korean Registered Patent Publication No. 0361073 “FISHING LINE FIXING DEVICE FOR REEL FISHING ROD” (Publication date: May 7, 2001.)

### SUMMARY OF THE INVENTION

To solve the above problems in the related art, an object of the present invention is to provide a fishing line clip device for a fishing reel, which stably fixes an end portion of a fishing line that is wound during separation of the fishing reel from a fishing rod and storage of the fishing reel in a state where the end portion is in close contact with a level winder, so that the fishing line is prevented from being tangled while being rolled into or unwound from a spool.

To achieve the above object, the present invention provides a clip device for fixing an end portion of a fishing line of a fishing reel, in which the clip device includes: a body member having a box-shaped structure with an open upper surface by coupling a support rod and a clamping rod; a movable member accommodated in the body member to be vertically movable, and configured to clamp the fishing line at a front thereof; and an elastic member interposed between the body member and the movable member.

According to the detailed configuration of the present invention, the body member may be formed of a resin material and formed at a front thereof with a clamping portion that is coupled by ultrasonic welding.

According to the detailed configuration of the present invention, the movable member may have a clamping portion at a front thereof, and may support a pad material on the clamping portion.

According to the detailed configuration of the present invention, the body member and the movable member may include stepped portions facing each other in a male-female relationship on the clamping portions, respectively.

According to a modification example of the present invention, the body member may further include a hanging portion for attaching and detaching the body member to and from the fishing reel.

According to the present invention as described above, the clip device may stably fix the end portion of the fishing line that is wound during separation of the fishing reel from the fishing rod and storage of the fishing reel in a state where the end portion is in close contact with the level winder, so that a damage thereof may be prevented, thereby simultaneously improving convenience and durability.

### BRIEF DESCRIPTION OF THE DRAWINGS

FIG. 1 is a schematic diagram of a state where a clip device according to the present invention is applied.

FIG. 2 is an exploded configuration diagram showing the clip device according to the present invention.

FIGS. 3A-3B are configuration diagrams showing an operation state of the clip device according to the present invention.

### DETAILED DESCRIPTION OF THE INVENTION

Hereinafter, the embodiments of the present invention will be described in detail with reference to accompanying drawings as follows.

The present invention proposes a clip device for fixing an end portion of a fishing line of a fishing reel. The present invention is based on a fishing line clip device required during separation of the fishing reel from a fishing rod and storage of the fishing reel, but is not necessarily limited thereto. There are several types of fishing reels, such as bait casting reels, spinning reels, conventional reels (also known as bait casting reels), and fly fishing reels. The main object of the present invention is to fix the end portion of the fishing line wound on the fishing reel while locating a spool on the top.

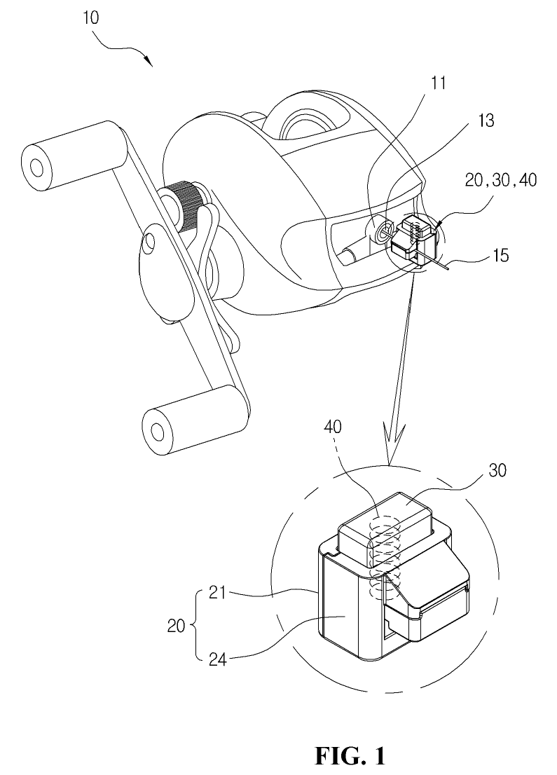

Referring to FIG. 1, a spool, a level winder 11, a hole 13, a fishing line 15, and the like constituting a bait casting reel 10 are shown. According to the present invention, the directions such as up and down, front and rear, and the like are named based on a state where the fishing line 15 is clamped as shown in FIG. 1.

The body member 20 according to the present invention has a box-shaped structure with an open upper surface by coupling a support rod 21 and a clamping rod 24.

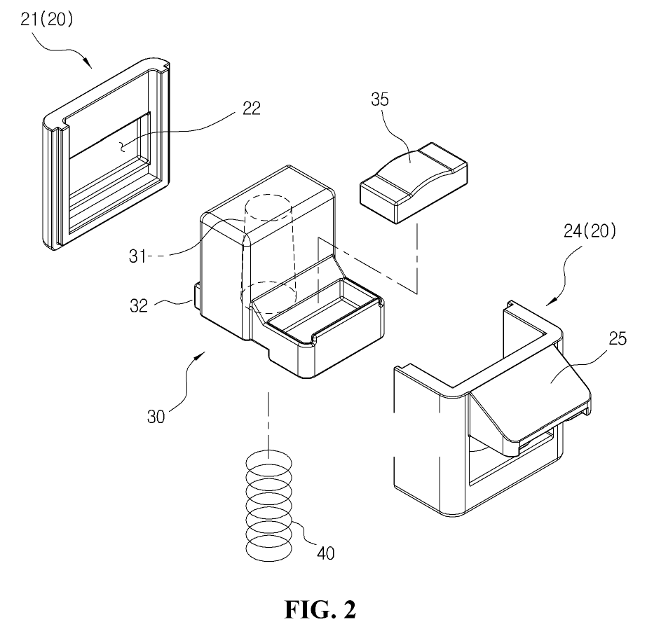

Referring to FIGS. 1 and 2, the support rod 21, a recessed portion 22, a clamping rod 24, and the like constituting the body member 20 are shown. The body member 20 has a structure in which a rear support rod 21 and a front clamping rod 24 are coupled. When the support rod 21 and the clamping rod 24 are coupled, a mounting groove with at least an open upper surface is formed. The recessed portion 22 communicates with the mounting groove inside the support rod 21, and is formed to have a height of approximately half.

According to the detailed configuration of the present invention, the body member 20 is formed of a resin material and formed at the front thereof with a clamping portion 25 that is coupled by ultrasonic welding.

In FIGS. 1 and 2, the support rod 21 and the clamping rod 24 of the body member 20 are coupled while accommodating other components in the mounting groove. The clamping portion 25 has a shape integrally protruding from the front of the clamping rod 24. An opening is formed from the front of the clamping rod 24 to a lower side of the clamping portion 25. The support rod 21 and the clamping rod 24 may be formed of a resin material which is harmless to humans and biodegradable. In the coupling of the support rod 21 and the clamping rod 24, ultrasonic fusion is preferred rather than the use of separate components such as screws. Obviously, when irregularities are formed in a coupling portion of the support rod 21 and the clamping rod 24, it is advantageous to increase a coupling force.

In addition, according to the present invention, the movable member 30, which is accommodated in the body member 20 to be vertically movable, is configured to clamp the fishing line at the front thereof.

In FIG. 1, a state where the movable member 30 is accommodated in the mounting groove of the body member 20 is shown. The movable member 30 is also formed of the same resin material as the body member 20, but a relatively soft material may be applied to at least a part thereof. The movable member 30 is supported to be vertically movable by the support rod 21 and the clamping rod 24. The movable member 30 may clamp the fishing line 15 in conjunction with the clamping portion 25 of the body member 20.

According to the detailed configuration of the present invention, the movable member 30 has a clamping portion 34 at the front thereof, and supports a pad member 35 on the clamping portion 34.

In FIG. 2, a protruding portion 32, the clamping portion 34, the pad material 35, and the like constituting the movable member 30 are shown. The protruding portion 32 protrudes from a rear of the movable member 30, and is slidably accommodated in the recessed portion 22 of the support rod 21. The recessed portion 22 and the protruding portion 32 guide a vertical movement of the movable member 30, and limits a movement range thereof. The clamping portion 34 integrally protrudes from the front of the movable member 30 to face the clamping portion 25 of the body member 20. The pad material 35 is formed of a rubber material having high friction coefficient and wear resistance so that the pad material 35 is in close contact with the clamping portion 25 on the clamping rod 24. The pad material 35 may further include irregularities in addition to a curved surface formed to increase a gripping force for clamping the fishing line 15.

In addition, according to the present invention, an elastic member 40 is interposed between the body member 20 and the movable member 30.

In FIGS. 1 and 2, a state where the elastic member 40 is connected to the body member 20 and the movable member 30 is shown. The elastic member 40 is accommodated in an accommodating groove 31 of the movable member 30 using a compression spring. A lower end of the elastic member 40 is in close contact with the body member 20. When the movable member 30 is pressed, the elastic member 40 is elastically compressed, and when the pressing of the movable member 30 is released, the elastic member 40 is restored.

According to the detailed configuration of the present invention, the body member 20 and the movable member 30 include stepped portions 27 and 37 facing each other in a male-female relationship on the clamping portions 25 and 34, respectively.

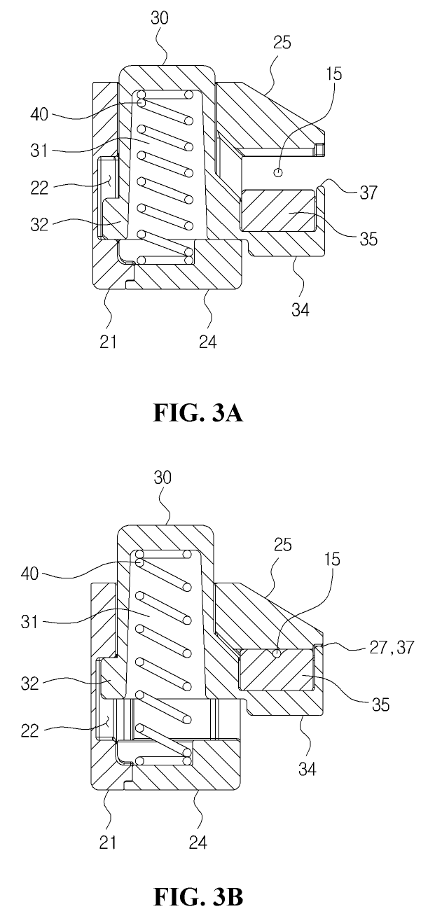

Referring to FIGS. 3A-3B, the stepped portions 27 and 37 formed respectively on the body member 20 and the movable member 30 are shown. The stepped portion 27 of the body member 20 is concavely formed, and the stepped portion 37 of the movable member 30 protrudes convexly. A protruding height of the stepped portion 37 of the movable member 30 is maintained to be higher than that of the pad material 35. This prevents the fishing line 15 clamped between the clamping portion 25 and the pad member 35 from being separated forward by an external force.

In a case where the bait casting reel 10 is stored as shown in FIG. 3A, when an upper surface of the movable member 30 is pressed, the upper and lower clamping portions 25 and 34 are widened so that the end portion of the fishing line 15 may be inserted therebetween, and in a case where the pressing of the movable member 30 is released as shown in FIG. 3B, the clamping portions 25 and 34 tightly grip the fishing line 15 by the elastic member 40.

In a case in the related art, when a clip having a metal material is used, a scratch is caused in the hole 13 of the level winder 11, and thus the fishing line is not smoothly unwound and wound, and there is a high risk of breaking during fishing.

According to a modification example of the present invention, the body member 20 further includes a hanging portion for attaching and detaching the body member 20 to and from the fishing reel.

Although not shown, the body member 20 may have a hanging portion for hanging the body member 20 on various parts of the fishing reel. When the bait casting reel 10 is stored as shown in FIG. 3B or an external force is applied during movement, the clip device oscillates or the fishing line is unwound. The hanging portion is formed in a shape of a groove engaged with the level winder 11 or the like, or is formed of a separate resin ring to prevent unnecessary oscillation of the clip device.

The present invention is not limited to the disclosed embodiments, and it is obvious to those skilled in the art that the present invention may be variously modified and changed without departing from the spirit and scope of the present invention. Therefore, it should be considered that such modifications or variations fall within the claims of the present invention.

What is claimed is:

1. A clip device for fixing an end portion of a fishing line of a fishing reel, the clip device comprising:
a body member (20) having a box-shaped structure with an open upper surface by coupling a support rod (21) and a clamping rod (24);
a movable member (30) accommodated in the body member (20) to be vertically movable, and configured to clamp the fishing line at a front thereof; and
an elastic member (40) interposed between the body member (20) and the movable member (30).

2. The clip device of claim 1, wherein the body member (20) is formed of a resin material and formed at a front thereof with a clamping portion (25) that is coupled by ultrasonic welding.

3. The clip device of claim 1, wherein the movable member (30) has a clamping portion (34) at a front thereof, and supports a pad material (35) on the clamping portion (34).

4. The clip device of claim 1, wherein the body member (20) and the movable member (30) include stepped portions (27, 37) facing each other in a male-female relationship on the clamping portions (25, 34), respectively.

5. The clip device of claim 1, wherein the body member (20) further includes a hanging portion for attaching and detaching the body member (20) to and from the fishing reel.
